(19) United States
(12) Patent Application Publication
(10) Pub. No.: US 2014/0193191 A1
(43) Pub. Date: Jul. 10, 2014

(54) ASSEMBLY COMPRISING A RADIALLY INTERMEDIATE JOINT

(71) Applicant: John F. van de Sanden, Nieuwegein (NL)

(72) Inventor: John F. van de Sanden, Nieuwegein (NL)

(21) Appl. No.: 14/233,815

(22) PCT Filed: Jul. 18, 2011
(86) PCT No.: PCT/EP2011/003581

§ 371 Date: Mar. 20, 2014

(51) Int. Cl. F16B 17/00; B21K 25/00

(52) U.S. Cl. CPC F16B 17/002; B21K 25/00
USPC 403/266; 29/505

(57) ABSTRACT

The present invention resides in an assembly comprising a first component (130) joined to a second component (120) by means of an intermediate joint. The first component has a first joining surface arranged coaxially and in spaced juxtaposition around a second joining surface of the second component, such that a radial gap is defined between the first and second joining surfaces. Furthermore, at least one of the first and second joining surfaces comprises a circumferential groove. The intermediate joint is formed by metal material that substantially fills the radial gap, whereby a first portion (141) of the intermediate joint comprises metal material that has been plastically deformed to fill the circumferential groove. According to the invention, the intermediate joint comprises a second portion (142), formed by metal material that has been welded or brazed to the first joining surface and to the second joining surface.

### FIELD OF THE INVENTION

The present invention relates to an assembly comprising a first component joined coaxially around a second component by means of a deformable insert that is pressed into a gap between the first and second components. The present invention further relates to a corresponding method of joining.

### BACKGROUND

One example of an assembly of the above-mentioned kind is known from U.S. Pat. No. 4,249,298. This document discloses an outer member (e.g. flywheel) joined to an inner member (e.g. shaft boss) by means of a connecting ring. A circumferential groove is formed on connecting surfaces of both members, and axial recesses are formed on an inner surface of each circumferential groove. Then, the connecting ring is placed between the inner and outer members. Finally, the connecting ring is pressed and plastically deformed such that material of the ring flows into the grooves and recesses.

Because the connecting surface of each circumferential groove has axial recesses—i.e. a toothed profile—the joint formed when the ring material flows between the teeth is capable of withstanding torque. However, the machining of a toothed profile into each connecting surface adds to the complexity and cost of the manufacturing process.

Consequently, there is room for improvement.

### DISCLOSURE OF THE INVENTION

The present invention resides in an assembly comprising a first component joined to a second component by means of an intermediate joint. The first component has a first joining surface arranged coaxially and in spaced juxtaposition around a second joining surface of the second component, such that a radial gap is defined between the first and second joining surfaces. Furthermore, at least one of the first and second joining surfaces comprises a circumferential groove. The intermediate joint is formed by metal material that substantially fills the radial gap, whereby a first portion of the intermediate joint comprises metal material that has been plastically deformed to fill the circumferential groove. According to the invention, the intermediate joint comprises a second portion, formed by metal material that has been welded or brazed to the first joining surface and to the second joining surface.

As a result, the intermediate joint as a whole is provided with additional strength.

Furthermore, the second portion of the intermediate joint prevents relative rotation between the first and second components and can be adapted to transfer torque. Thus, an assembly according to the invention comprises an intermediate joint with improved functionality, which can be manufactured in a straightforward and cost-efficient manner.

In a first embodiment of the invention, the first portion and the second portion of the intermediate joint comprise the same metal material. Suitably, the intermediate joint is formed by a metal insert ring that is pressed into the radial gap. A first part of the ring is plastically deformed to adopt the shape of the gap and a second part of the ring is welded or brazed to the first and second components. Preferably, the metal insert ring has a volume that is at least equal to the volume of the radial gap, so that the entire gap is filled.

The second portion of the intermediate joint may further comprise metal material that is different from the metal material of the first portion. For example, if the insert ring material and the material of the first and second components have limited weldability/brazeability, the welding or brazing process is suitably carried out using a filler material that promotes the formation of a welded or brazed joint. In one example, when the first and second components are made of bearing steel and the insert ring is made of a high-strength steel, a Nickel alloy filler is preferably used.

In other examples, the first component is made of a first metal and the second component is made of a second metal. The second portion of the intermediate joint may then comprise more than one different metal material. Suitably, a first filler material compatible with the insert ring material and the first metal may be used to facilitate a join between the insert ring and the first joining surface, while a second filler material is used to facilitate a join between the insert ring and the second joining surface.

In an alternative example, the insert ring is made of a filler material that is suitable for forming a welded/brazed joint with the first and second joining surfaces. The advantage of this alternative is that a good welded or brazed joint can be quickly and easily formed, simply with the aid of e.g. a laser beam or an electron beam.

In a second embodiment of the invention, the first portion of the intermediate joint comprises a first insert ring of a first metal material and the second portion comprises a second insert ring of a second metal material. Suitably, the second metal material comprises a filler material as described above, which enables the formation of a good welded or brazed joint between the second insert ring and the first and second joining surfaces. In a preferred example of the second embodiment, the first metal material has a higher yield strength than the second metal material, to optimise the strength of the intermediate joint as a whole.

In a third embodiment of the invention, the first portion of the intermediate joint comprises a plastically deformed metal insert ring, whereby the ring has a volume less than the volume of the radial gap. The remaining volume of the radial gap is filled with a metal filler that is added during a welding or brazing process, for example: a hybrid laser welding process. Again, the metal material of the plastically deformed insert ring preferably has a higher yield strength than the metal filler material.

A key advantage of an assembly according to the invention is that, because the intermediate joint comprises first and second portions, each portion can be optimally adapted to perform a specific function, depending on the application requirements

For example, in applications where one of the first and second components is subjected to torque, the second portion of the intermediate joint may be adapted to enable torque transfer between the first and second components. Suitably, the metal material of the second portion and the depth of the applied weld/braze are selected to provide the required torque-transfer capability.

A heat joint such as a weld can be readily adapted to take up radial loads and withstand torque. The axial strength of a heat joint, however, is generally less good. Therefore, in applications where one of the first and second components is subjected to axial loading, the geometry of the first portion of the intermediate joint is suitably adapted to provide the majority of the required axial strength.

In a preferred embodiment, the circumferential groove in the radial gap is formed by a concave portion in one of the first and second joining surfaces. The other of the first and second joining surfaces is provided with a convex portion, radially opposite from the concave portion. Consequently, the radial gap has a section with an arcuate geometry. An insert ring, pressed into the arcuate section, is then plastically deformed such that material of the insert ring fills the concave portion and surrounds the convex portion. Consequently, the first and second components are locked relative to each other in both axial directions. Further, the aforementioned arcuate geometry allows the insert ring to be made from a high strength material, meaning that the (first portion of the) intermediate joint has excellent shear strength in both axial directions.

The present invention also defines a method of joining a first component to a second component by means of an intermediate joint comprising metal material that substantially fills a radial gap between a first joining surface on the first component and a second joining surface in the second component. The method comprises steps of:
providing a circumferential groove on one of the first and second joining surfaces;
arranging the first component coaxially around the second component such that the first and second joining surfaces are radially opposite each other and the radial gap is formed therebetween;
pressing a first metal insert ring into the radial gap, such that metal material of the ring plastically deforms to fill the groove.

According to the invention, the method further comprises a step of welding or brazing metal material of the intermediate joint to the first joining surface and to the second joining surface.

An assembly according to the invention, and the corresponding method of joining, are particularly advantageous in bearing applications. In some examples, the first component is a separate inner ring of a wheel bearing unit and the second component is a flanged hub. In other examples, the first component is a bearing inner ring and the second component is a shaft. In still further examples, the first component is a flange and the second component is a bearing outer ring.

The invention is not restricted to bearing applications, however. The first component may be a crown gear that is joined to a differential housing (second component) by means of an intermediate joint comprising first and second portions.

As demonstrated, an assembly according to the invention has several advantages and a wide range of applications. Other advantages and uses will become apparent from the detailed description and accompanying figures.

### BRIEF DESCRIPTION OF THE DRAWINGS

FIG. 1a is a cross-sectional view of an assembly comprising an intermediate joint according to the invention, where the assembly is part of a first wheel bearing unit;

FIG. 1b-1e are detail views of the intermediate joint depicted in FIG. 1a, in various stages of its formation;

FIG. 2 is a part cross-sectional view of an assembly comprising first and second intermediate joints according to the invention, where the assembly is part of traction motor bearing unit;

FIG. 3 is a part cross-sectional view of a further assembly according to the invention, where the further assembly is part of a second wheel bearing unit.

### DETAILED DESCRIPTION

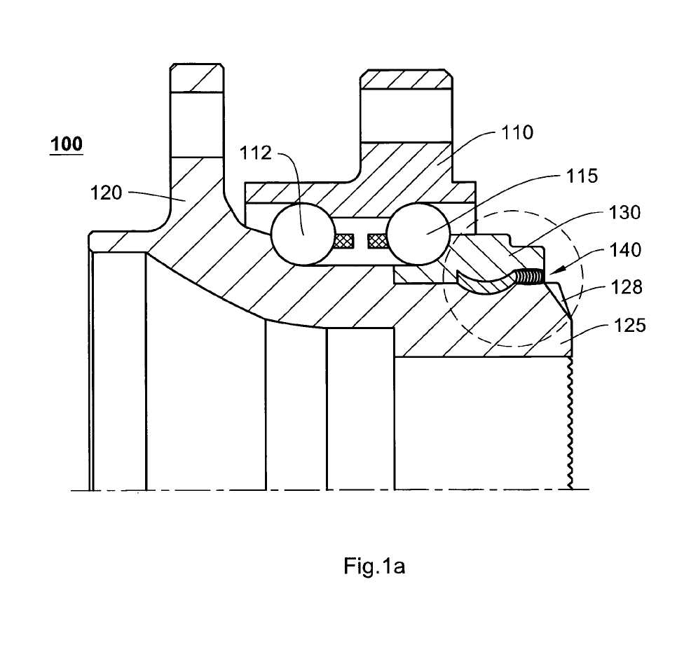

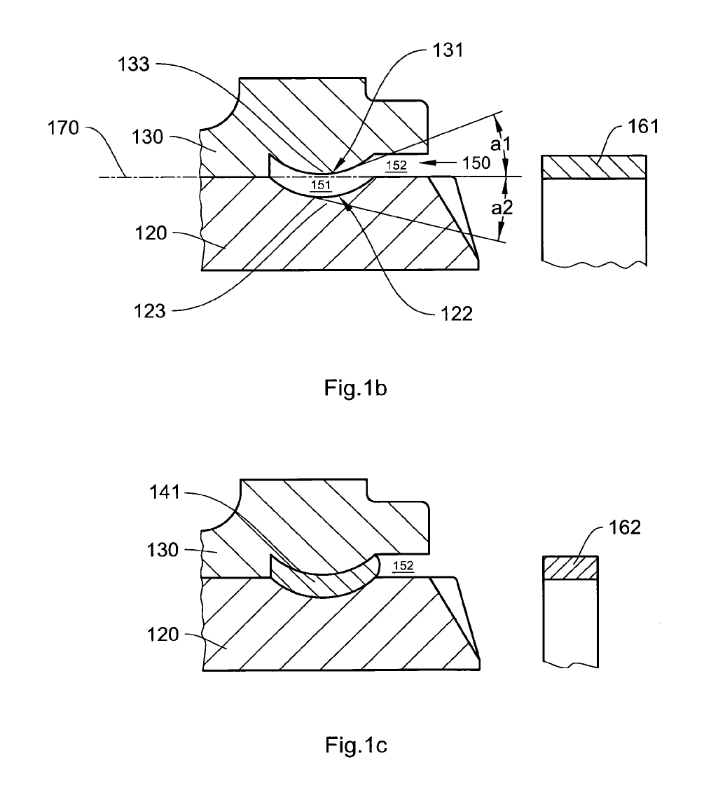

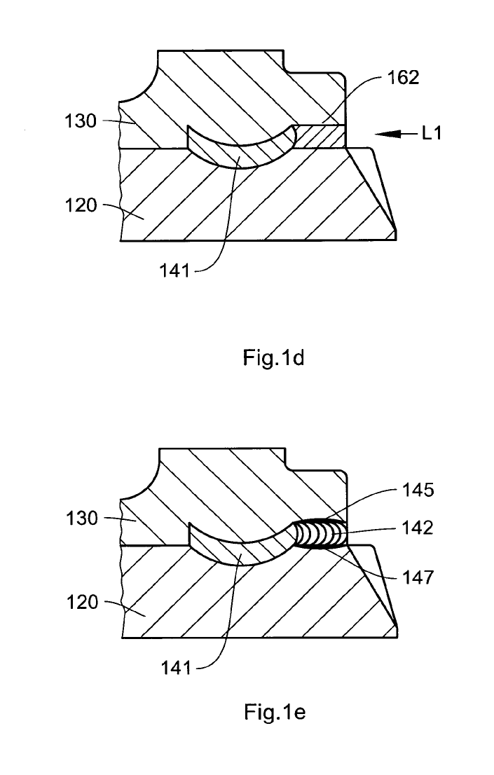

An example of an assembly according to the invention is shown in cross-section in FIG. 1a. The assembly is part of a wheel bearing unit 100 having an outer ring 110 with first and second outer raceways for accommodating a first row 112 and a second row 115 of rolling elements. The bearing unit further comprises a flanged inner ring 120 which has a first inner raceway for the first row of rolling elements 112. The second inner raceway for the second row of rolling elements 115 is provided on a separate inner ring 130. The separate inner ring is necessary in order to allow the second row of rolling elements to be inserted into the hub unit 115 after the outer ring 110 has been mounted over the first row 112. The separate inner ring 130 is mounted on a nose part 125 of the flanged inner ring 120. In conventional hub units, the nose part comprises an axial extension, which is orbitally formed around the separate inner ring, to lock up the bearing unit and set the desired amount of preload. The required axial extension adds to the material costs and weight of the hub unit. Also, because the axial extension needs to be deformable, while other parts of the flanged inner ring need to be induction hardened, an inadvertent hardening of part of the axial extension can lead to cracking when the extension is orbitally formed.

These drawbacks are overcome in an assembly according to the invention in that the separate inner ring 130 is joined to the flanged inner ring 120 by means of an intermediate joint 140. The intermediate joint comprises at least one metal insert ring that is pressed into a radial gap between the separate inner ring and the flanged inner ring. The radial gap comprises a non-cylindrical section and the ring material is plastically deformed to adopt the shape of the non-cylindrical section.

The wheel bearing unit in this example is adapted for driven rotation of the flanged inner ring 120. The nose part 125 of the flanged inner ring is provided with axial spines 128 for engagement with axial splines on the output shaft of a constant velocity joint. Thus, torque can be transferred to the flanged inner ring 120 and to a vehicle wheel attached to the flange part of the flanged inner ring 130. According to the invention, torque can be transferred from the flanged inner ring 120 to the separate inner ring 130 via the intermediate joint 140 in that the joint further comprises metal material that is welded or brazed to the separate inner ring and to the flanged inner ring.

Thus an assembly according to the invention comprises an intermediate joint which has a first section and a second section. The first section comprises a plastic deformation joint and the second section comprises a heat joint. This will be explained in more detail with reference to FIGS. 1b-1e, which show exploded views of the joint 140 in FIG. 1a, in various stages of its formation.

FIG. 1b is a detail of the separate inner ring and the flanged inner ring, prior to formation of the joint. A first joining surface 131 is machined into a radially inner surface of the separate inner ring 130, and second joining surface 122 is machined into a radially outer surface of the flanged inner ring 120. When the separate inner ring 130 is placed coaxially around the flanged inner ring 120, a radial gap 150 is defined between the first and second joining surfaces 131, 122. In the depicted example, the radial gap has a first section 151 and a second section 152, whereby the first section has an arcuate geometry and the second section has a cylindrical geometry. The arcuate section 151 of the radial gap is formed in that the first joining surface 131 has a convex portion 133 and the second joining surface 122 has a concave portion 123, opposite from the convex portion. Alternatively, the concave portion may be provided in the first joining surface of the separate inner ring and the convex portion may be provided in the second joining surface of the flanged inner ring.

The first section of the intermediate joint is formed by a first insert ring 161, which is pressed into the arcuate section 151 of the radial gap 150. Preferably, so as to completely fill the arcuate section, the first insert ring 161 has a volume that is at least equal to the volume of the arcuate section. In the example shown in FIG. 1b the first insert ring 161 has a thickness of 1 mm and is made from a heat-treatable steel—i.e. a quenched and tempered steel—with a yield strength of approximately 1000 MPa; for example, a steel of grade DIN C55.

As the first insert ring 161 is being pressed into the cylindrical section 152 of the radial gap 150, a leading edge of the ring 161 will strike the convex portion 133 of the first joining surface 131. The leading edge is then deflected into the arcuate section 152 and the ring material will plastically deform around an apex of the curved gap, to fill the arcuate section 151. Suitably, a maximum radial gap between the first and second joining surfaces of the arcuate section is equal to the thickness of the first insert ring 161. Thus, plastic deformation of the insert ring 161 does not involve radial expansion, which allows the use of a high-strength material of limited ductility.

The limited ductility of the first insert ring in this example places some constraints on the geometry of the arcuate section 151. Firstly, the convex portion 133 should not protrude into a recess defined by the concave portion 123. Secondly, the angle which the convex portion of the first joining surface 131 presents to the leading edge of first insert ring 161 should not be too steep. When the ring is made of a DIN C55 grade steel, the convex portion suitably has a maximum angle a₁ of 28-35 degrees, relative to a reference line 170, parallel to the bearing axis of rotation.

Similarly, after the ring material has flowed around the apex of the gap, the angle a₂ which the concave portion of the second joining surface presents to the leading of the insert ring 161 also should not be too steep. For a DIN C55 grade steel, the angle a₂ relative to reference line 170 suitably lies between 28 and 35 degrees. When the first insert ring 161 is made of a more ductile material, such as e.g. mild steel, the angles a₁ and a₂ may be steeper.

Furthermore, the convex portion 133 and the concave portion 123 may, as shown in FIGS. 1a-1e, be defined by a radius of curvature. Alternatively, they may be formed by oppositely oriented conical surfaces.

FIG. 1c shows a detail of the first section 141 of the intermediate joint, formed after the first insert ring 161 has been pressed into the arcuate section 151. The insert ring has been plastically deformed, such that steel material surrounds the convex portion 133 and fills the concave portion 123. As a result, the first section 141 of the intermediate joint axially locks the flanged inner ring 120 and the separate inner ring 130 with respect to each other in both axial directions. Further, since the first insert ring has a high yield strength, the first section 141 of the joint has excellent shear strength in both axial directions. The first section of the joint also provides radial locking, in that the deformed insert ring has a radial thickness equal to that of the arcuate section of the radial gap.

As mentioned above, torque transfer via the intermediate joint 140 shown in the example of FIG. 1a is enabled via the second section of the intermediate joint, which incorporates a heat joint. The second section in this example comprises a second insert ring 162, which is pressed into the cylindrical portion 152 of the radial gap, after the first ring has been pressed in. The second insert ring 162 is suitably made from a nickel alloy, which is compatible with bearing steel in terms of forming a welded joint.

FIG. 1d shows a detail of the assembly after the second insert ring 162 has been pressed into the radial gap. In this example, the second insert ring is laser welded to the separate inner ring and the flanged inner ring. A laser beam L1 is directed at the second insert ring 162. A relatively low laser power of approx. 2 kW may be used to weld the nickel alloy insert ring 162 to the bearing steel rings 130, 120. This is advantageous in that the welding process will not produce high temperatures that adversely affect the hardness of the separate inner ring or the nose part of the flanged inner ring.

The resulting joint in accordance with the invention, comprising a first section 141 and a second section 142 is shown in FIG. 1e. The laser melts the nickel alloy material of the second insert ring, as well as a first portion 145 of the bearing steel of the separate inner ring 130 and a second portion 147 of the bearing steel of the flanged inner ring 120. Consequently, torque transfer is possible from the flanged inner ring to the separate inner ring.

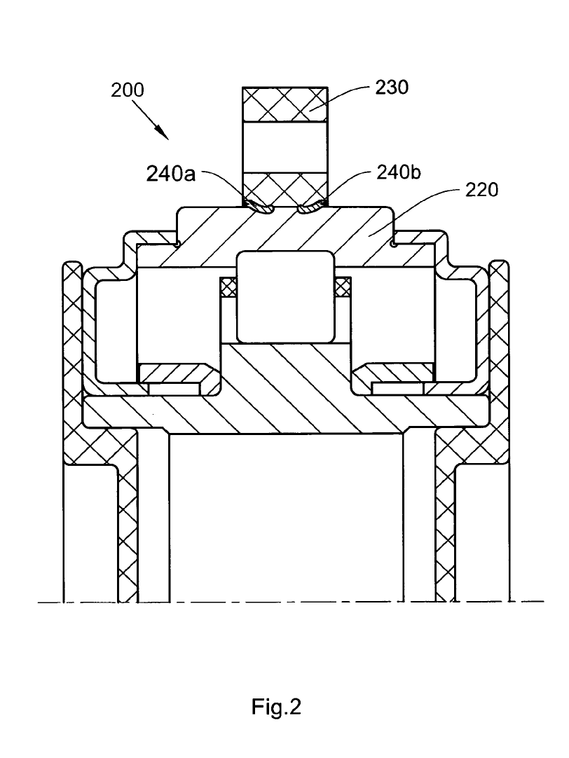

A further example of an assembly according to the invention is shown in FIG. 2.

The assembly is part of a traction motor bearing unit (TMBU) for rail applications. In this example, the TMBU 200 comprises a mounting flange 230 that has been joined to a bearing outer ring 220 by means of a first intermediate joint 240a and a second intermediate joint 240b. The bearing outer ring is made of bearing steel, so that an outer raceway of the ring 220 can be hardened to withstand rolling contact fatigue.

In a conventional TMBU, the outer ring comprises an integral flange. Generally, flanged bearing rings are manufactured by means of hot forging, after which the flanged ring is machined to the desired tolerances. One advantage of forming a flanged ring from two separate parts is that the flange part and the ring part can be machined separately. The flange and the ring are simple shapes which are more economical to machine than objects of more complex shape, such as a flanged ring. Furthermore, the flange part can be made of a non-bearing-grade steel, which is less expensive than bearing steel. In the example of FIG. 2, the mounting flange 230 is made of mild steel.

The first and second intermediate joints 240a, 240b are formed in the same way and will be described with reference to the first intermediate joint. First and second joining surfaces are machined into the flange part 230 and the bearing outer ring 220, such that a radial gap is created with a geometry similar to the radial gap shown in FIG. 1b. A single insert ring with a volume essentially equal to the volume of the radial gap is pressed in. In this example, the insert ring is made of ? steel, which has a yield strength of ? MPa. After pressing, the insert ring is brazed to outer ring 220 and flange 230 using a laser beam or an electron beam, at a brazing temperature of around 1200 degrees.

The brazed joint adds to the strength of first and second intermediate joints 240a, 240b and also closes off each joint, so that no moisture can penetrate into the interfaces between the insert ring and the flange and outer ring.

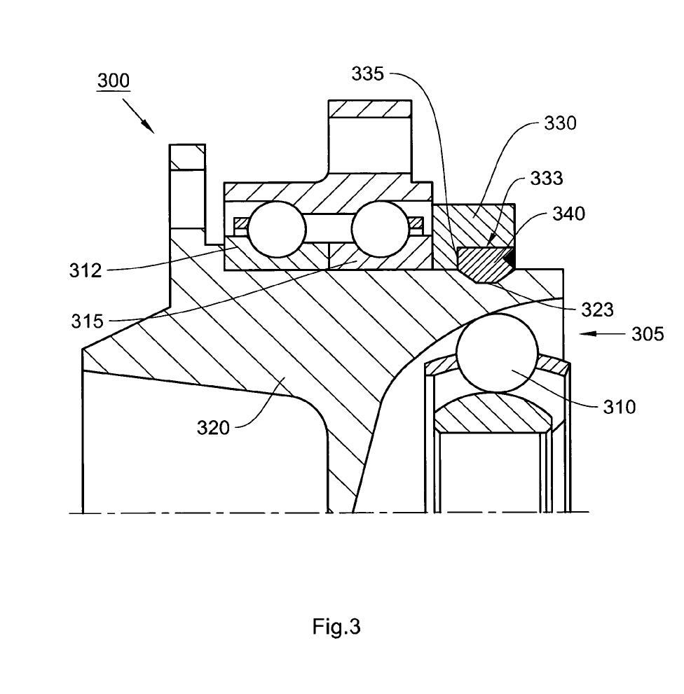

A third example of an assembly according to the invention is shown in FIG. 3. The assembly is part of wheel bearing unit 300 adapted for driven rotation of a flanged hub 320, whereby a bore of the flanged hub comprises an outer raceway for ball elements 310 of a constant velocity joint 305. In this example, the flanged hub has a seat for two bearing inner rings 312, 315 and the unit is locked up and axially preloaded by means of a locking ring 330. The flanged hub 320 is made of bearing steel and the locking ring 330 made of mild steel. The locking ring is joined to the flanged hub by means of an intermediate joint 340 comprising a deformation joint and a heat joint

An outer circumference of the flanged hub 320 is provided with a groove 323—i.e.

a concave joining surface. The locking ring has a stepped portion 325. Accordingly, the locking ring 330 has a first cylindrical surface with an inner diameter d₁ that corresponds to the inner diameter of the bearing inner rings, and has a second cylindrical surface 333 with an inner diameter d₂ greater than d₁. Thus, when the locking ring 330 is mounted over the flanged hub 320, a radial gap is created between the second cylindrical surface 333 and the groove 323. In this example, the radial gap is filled with a single insert ring made of a nickel alloy. The ring has a thickness that is essentially equal to d₂-d₁. The ring is pressed into the gap until a leading edge of the ring strikes the stepped portion 325 of the locking ring 330. Axial pressure is then applied to the ring, such that the ring material deforms radially and fills the groove 323, to provide axial locking in both directions. The insert ring is then welded to the locking ring 330 and the flanged hub 320.

The weld prevents relative rotation between the flanged hub and the locking ring and prevents the entry of moisture that would damage the joint due to corrosion.

A nickel alloy insert ring is advantageous in this example, not only because it forms a good weld with bearing steel, but also because it has the required ductility to enable radial expansion during plastic deformation.

A number of aspects/embodiments of the invention have been described. It is to be understood that each aspect/embodiment may be combined with any other aspect/embodiment. The invention may thus be varied within the scope of the accompanying patent claims.

### REFERENCE NUMERALS

100 Wheel bearing unit
110 Outer ring
112 First row of rolling elements
115 Second row of rolling elements
120 Flanged inner ring
122 Second joining surface on flanged inner ring
123 Concave portion of second joining surface
125 Nose part of flanged inner ring
128 Axial splines on nose part
130 Separate inner ring
131 First joining surface on separate inner ring
133 Convex portion of first joining surface
140 Intermediate joint
141 First section of intermediate joint
142 Second section of intermediate joint
150 Radial gap between first and second joining surfaces
151 Arcuate section of radial gap
152 Cylindrical section of radial gap
161 First insert ring
162 Second insert ring
170 Reference line parallel to bearing axis of rotation
a₁ Maximum angle of convex portion relative to reference line
a₂ Maximum angle of concave portion relative to reference line
200 Traction motor bearing unit
220 Outer ring of TMBU
230 Mounting flange of TMBU
240a First intermediate joint
240b Second intermediate joint
300 Wheel bearing unit
305 Constant velocity joint
310 Ball of constant velocity joint
312 First inner ring
315 Second inner ring
320 Flanged hub
323 Groove in outer circumference of flanged hub
330 Locking ring
333 Second cylindrical surface of locking ring
335 Stepped portion of locking ring

1. An assembly comprising:
a first component joined to a second component by means of an intermediate joint,
the first component having a first joining surface arranged coaxially and in spaced juxtaposition around a second joining surface of the second component, such that a radial gap is defined between the first and second joining surfaces,
at least one of the first and second joining surfaces providing a circumferential groove,
the intermediate joint having metal material that substantially fills the radial gap, wherein
a first portion of the intermediate joint is formed by metal material that has been plastically deformed to fill the circumferential groove, and wherein
the intermediate joint provides a second portion, formed by metal material that has been one of either welded and brazed to the first joining surface and to the second joining surface.

2. The assembly according to claim 1, wherein the second portion of the intermediate joint provides the same metal material as the metal material of the first portion.

3. The assembly according to claim 1, wherein the second portion of the intermediate joint provides metal material that is different from the metal material of the first portion.

4. The assembly according to any one of claims 1, wherein the first and second portions include an insert ring with a volume that is essentially equal to the volume of the radial gap.

5. The assembly according to claim 3, wherein the first portion of the intermediate joint provides a first insert ring and the second portion provides a second insert ring.

6. The assembly according to claim 1, wherein the metal material of at least the first portion of the intermediate joint comprises a high-strength steel.

7. The assembly according to any preceding claim 1, wherein at least one of the first and second components is made of bearing steel

8. The assembly according to claim 7, wherein the metal material of at least the second portion of the intermediate joint comprises metal that has welding or brazing compatibility with bearing steel.

9. The assembly according to any preceding claim 1, wherein the circumferential groove is formed by a concave portion on one of the first and second joining surfaces and, radially opposite therefrom, the other of the first and second joining surfaces comprises a convex portion, such that the radial gap comprises an arcuate section.

10. The assembly according to claim 9, wherein an insert ring pressed into the arcuate section has a thickness in an undeformed state, which is equal to a maximum radial gap between the convex portion and the concave portion.

11. A method of joining a first component to a second component, by means of an intermediate joint having metal material that substantially fills a radial gap between a first joining surface on the first component and a second joining surface on the second component, the method comprising steps of:
providing a circumferential groove on one of the first and second joining surfaces;
arranging the first component coaxially around the second component such that the first and second joining surfaces are radially opposite each other, the radial gap being formed therebetween;
pressing a first metal insert ring into the radial gap, such that metal material of the ring plastically deforms to fill the circumferential groove; and wherein characterized in that, the method further comprises:
one of welding and brazing metal material of the intermediate joint to the first joining surface and to the second joining surface.

12. The method according to claim 11, wherein the first metal insert ring has a volume substantially equal to the volume of the radial gap.

13. The method according to claim 11, wherein the first metal insert ring has a volume less than the volume of the radial gap and the method comprises a further step of pressing a second metal insert ring into the radial gap and the step of welding or brazing comprises welding or brazing metal material of the second insert ring to the first and second joining surfaces.

14. The method according to claim 13, wherein the first insert ring is made of metal material with a higher yield strength than the metal material of the second insert ring.

15. The method according to claim 11, wherein the first metal insert ring has a volume less than the volume of the radial gap and the step of one of welding and brazing further comprises a hybrid welding or brazing process in which a filler material is used to create the second portion of the intermediate joint.
